(19) United States
(12) Patent Application Publication
(10) Pub. No.: US 2008/0152976 A1
(43) Pub. Date: Jun. 26, 2008

(54) Fuel cell system

(75) Inventors: Masanori Uehara, Kariya-shi (JP); Takashi Koyama, Kariya-shi (JP)

Correspondence Address: OLIFF & BERRIDGE, PLC, P.O. BOX 320850, ALEXANDRIA, VA, 22320-4850, US

(73) Assignee: DENSO CORPORATION, KARIYA-SHI (JP)

(21) Appl. No.: 12/004,030

(22) Filed: Dec. 20, 2007

(30) Foreign Application Priority Data
Dec. 20, 2006 (JP) 2006-342770

(51) Int. Cl. H01M 8/04

(52) U.S. Cl. 429/26

(57) ABSTRACT

In a fuel cell system, a heat exchanger performs heat exchange between a refrigerant and an oxygen gas emitted from a fuel cell stack. A four-way valve selects one of refrigerant passages according to a heating mode and a cooling mode. In the refrigerant passage selected for the heating mode, the refrigerant emitted from the compressor flows through an indoor second heat exchanger, a decompressor for heating, an outdoor heat exchanger, and an exhaust gas heat exchanger, and then returned to an inlet of the compressor. In the refrigerant passage selected in the cooling mode, the refrigerant emitted from the compressor flows through the exhaust gas heat exchanger, the outdoor heat exchanger, a decompressor for cooling, and an indoor heat exchanger for cooling, and then returned to the inlet of the compressor.

### CROSS-REFERENCE TO RELATED APPLICATION

This application is related to and claims priority from Japanese Patent Application No. 2006-342770 filed on Dec. 20, 2006, the contents of which are hereby incorporated by reference.

### BACKGROUND OF THE INVENTION

1. Field of the Invention

The present invention relates to a fuel cell system equipped with a fuel cell stack which is capable of generating electrical energy by electrochemical reaction of combining hydrogen gas and oxygen gas, and suitably applicable to electrical generator for movable bodies such as motor vehicles, electric vehicles, marine vessels, portable generators, and other mobile devices equipped with a refrigeration cycle system for air conditioning and the like.

2. Description of the Related Art

Various fuel cell systems which have been proposed, which having a thermal mechanism in which a fuel cell system and an air conditioning heat pump are combined, for example, the Japanese patent laid open publication No. JP2002-81792 has disclosed a fuel cell system having such a thermal mechanism. During a heat mode, such a fuel cell system promotes the evaporation of a refrigerant in an evaporator side at a low pressure side which is heated using heat energy of cooling water which is circulated through a fuel cell stack, in order to increase the pressure of the refrigerant to increase the efficiency of an air conditioning heat pump system. On the contrary, during a cooling operation mode, the fuel cell system decreases the temperature of the refrigerant by evaporating the cooling water for the fuel cell stack on a surface of a high pressure radiator in order to decrease the pressure of the refrigerant and to increase the efficiency of the air conditioning heat pump system.

However, the system disclosed in JP2002-81792 having the configuration in which the evaporator at a low pressure side is heated using the cooling water for the fuel cell stack during the heating operation mode requires an additional heat exchanger for performing heat exchange between the cooling water and the refrigerant. In addition to such a drawback, because the system is on condition of heating using sensible heat, the system can not heat the refrigerant until the temperature of the fuel cell stack reaches a predetermined temperature. Thus, the related-art system having the above configuration cannot perform the fast heating.

On the other hand, the system using the latent heat in evaporation of the cooling water for the fuel cell stack during the cooling operation mode needs to specially incorporate an additional path through which the cooling water is supplied to the radiator at a high pressure side. The system further needs to incorporate a spray means for spraying the cooling water and a drain path through which non-evaporated cooling water is discharged. This causes a complicated configuration of the fuel cell system.

### SUMMARY OF THE INVENTION

It is an object of the present invention to provide a fuel cell system performing air conditioning using heat pump capable of performing rapid heating operation with a simple configuration with high efficiency.

To achieve the above purposes, the present invention provides a fuel cell system has a fuel cell stack, a compressor, a first heat exchanger, a second heat exchanger, a first decompressor, a third heat exchanger, a second decompressor, a fourth heat exchanger, and a refrigerant passage switch means. The fuel cell stack generates electrical energy by electrochemical reaction of combining fuel gas and oxidizing agent gas. The compressor compresses refrigerant for use in air conditioning. The first heat exchanger performs heat exchange between an outdoor air and a refrigerant emitted from the compressor. The second heat exchanger performs heat exchange between the outdoor air and the refrigerant. The first decompressor decreases a pressure of the refrigerant flowing from the second heat exchanger. The third heat exchanger cools the air for air conditioning by evaporating the refrigerant whose pressure is decreased by the first decompressor. The second decompressor decreases the pressure of the refrigerant compressed by the compressor. The fourth heat exchanger performs heat exchange between the refrigerant and the oxidizing agent off-gas emitted from the fuel cell stack. The refrigerant passage switch means selects one of a refrigerant passage for a cooling operation mode and a refrigerant passage for a heating operation mode. In the fuel cell system, the refrigerant passage for the cooling operation mode is composed of the fourth heat exchanger, the second heat exchanger and the second decompressor in order. The refrigerant passage for the heating operation mode is composed of the second decompressor, the second heat exchanger, and the fourth heat exchanger in order. In the cooling operation mode of the fuel cell system, the refrigerant emitted from the electric compressor (or an electric compressor) is cooled using the oxidizing agent off-gas exhausted from the fuel cell stack by the fourth heat exchanger, the refrigerant is cooled further using the outdoor air by the second heat exchanger, the pressure of the refrigerant is then decreased by the first decompressor, the refrigerant is evaporated by the third heat exchanger in order to cool the air for use in the air conditioning, and the refrigerant is returned to an inlet of the compressor. In the heating operation mode of the fuel cell system, the refrigerant emitted from the compressor heats the air for use in the air conditioning, the pressure of the refrigerant is decreased by the second decompressor, the refrigerant is heated using the outdoor air by the second heat exchanger, the refrigerant is heated using the oxidizing agent off-gas discharged from the fuel cell stack by the fourth heat exchanger, and the refrigerant is returned to the inlet of the compressor.

During the heat operation mode of the fuel cell system, because the heat energy of the refrigerant of a high temperature which has been compressed by the compressor can be conducted to the air for the air conditioning through the first heat exchanger, it is possible for the fuel cell system to heat the indoor air of a passenger compartment of the vehicle immediately after the initiation of the fuel cell stack. Further, a simple configuration composed of the fourth heat exchanger and the refrigerant passage switch valve enables that the latent heat energy of the produced water generated by electrochemical reaction in the fuel cell stack is conducted to the refrigerant, where the fourth heat exchanger is located at the upstream side or the downstream side observed from the second outdoor heat exchanger, and capable of performing heat exchange between the oxidizing agent off-gas emitted form the fuel cell stack and the refrigerant, and the refrigerant passage switch valve is capable of switching the refrigerant passage having the second heat exchanger and the fourth heat exchanger. This can improve the heating efficiency and the cooling efficiency in the refrigeration cycle of the fuel cell system.

On the other hand, during the cooling operation mode of the fuel cell system, the refrigerant passage from the fourth heat exchanger to the second heat exchanger enables that the refrigerant can be cooled in advance, before the refrigerant is cooled by the second heat exchanger, using the sensible heat energy of the oxidizing agent off-gas exhausted from the fuel cell stack and the latent heat energy in evaporation of the production water supplied from the fuel cell stack. It is thereby possible to efficiently decrease the temperature of the refrigerant and to efficiently decrease the pressure of the refrigerant, to promote the condensation of the refrigerant into the liquid state by the second heat exchanger. This can increase the efficiency of the fuel cell system.

Still further, during the heating operation mode, making the refrigerant passage from the second heat exchanger to the fourth heat exchanger enables that the refrigerant heated by the second heat exchanger is further heated using the sensible heat energy of the oxidizing agent off-gas exhausted from the fuel cell stack and the latent heat energy in condensation of the production water generated by the electrochemical reaction in the fuel cell stack. It is thereby possible to increase the pressure of the refrigerant, to decrease the load of the compressor, and to improve the cooling efficiency of the fuel cell system.

Still further, incorporating the mist accelerator capable of producing a mist state of water component contained in the oxidizing agent off-gas exhausted from the fuel cell stack can promote making the mist state of water component contained in the oxidizing agent gas exhausted from the fuel cell stack. That is, because the mist accelerator can increase the amount of fine water drop in the oxidizing agent off-gas, it is thereby possible to increase the amount of the water component which can be evaporated by the fourth heat exchanger.

It is thereby possible to increase the amount of the latent energy in evaporation of the oxidizing agent gas during the cooling operation mode and to improve the cooling efficiency of the refrigerant and further to improve the operation efficiency of the fuel cell system.

Still further, it is possible to perform the heating operation using the heat energy generated by the electrical generation in the fuel cell stack by incorporating the fifth heat exchanger capable of performing the heat exchange between the cooling water for use in the fuel cell stack and the air for use in the air conditioning in order to heat the air for the air conditioning.

### BRIEF DESCRIPTION OF THE DRAWINGS

A preferred, non-limiting embodiment of the present invention will be described by way of example with reference to the accompanying drawings, in which:

FIG. 1 is a schematic configuration of a fuel cell system according to a first embodiment of the present invention;

FIG. 2 is a block diagram showing a controller (ECU) in the fuel cell system shown in FIG. 1;

FIG. 3A is a schematic view showing the refrigerant flow in a heating operation mode of a refrigeration cycle in the fuel cell system shown in FIG. 1;

FIG. 3B is a schematic view showing the refrigerant flow in a cooling operation mode of the refrigeration cycle in the fuel cell system shown in FIG. 1; and

FIG. 4 is a schematic configuration of a fuel cell system according to a second embodiment of the present invention.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Embodiment

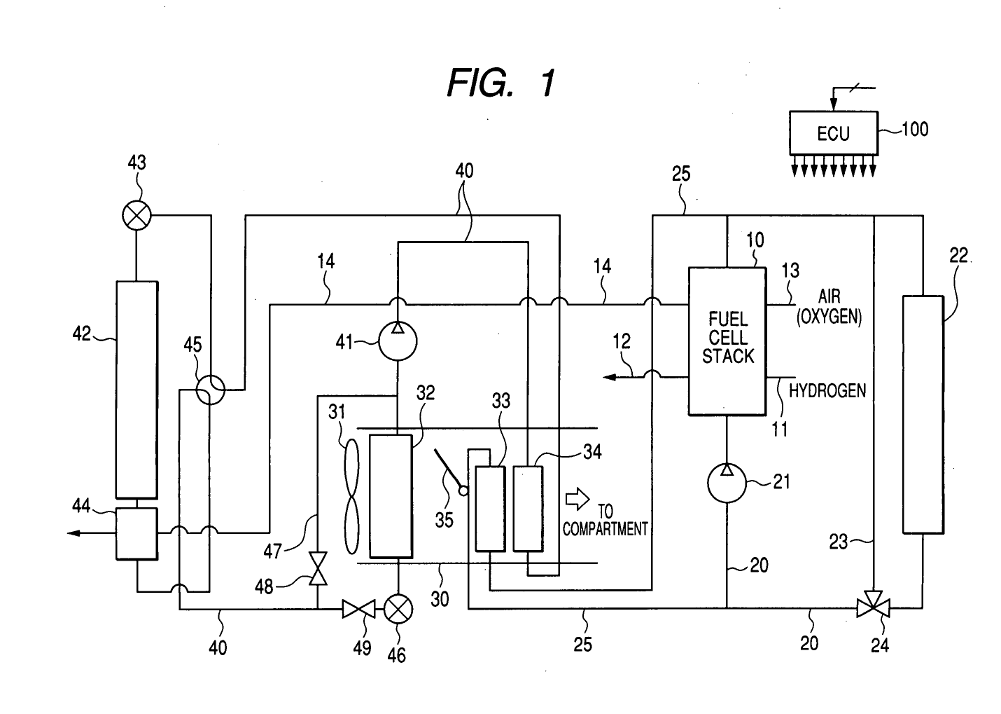

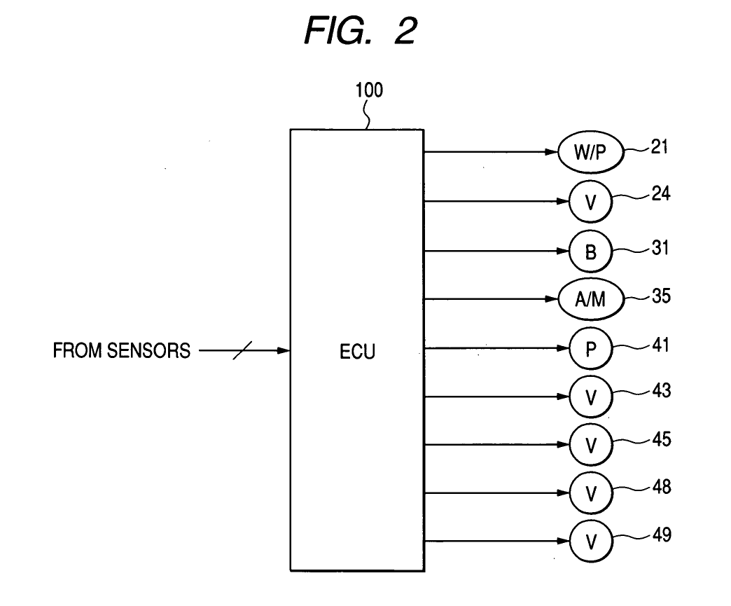

A description will be given of the fuel cell system according to the first embodiment of the present invention with reference to FIG. 1 and FIG. 2. The first embodiment according to the present invention shows an example of the fuel cell system which is applied to an electric vehicle (or a fuel cell vehicle) which moves using electrical energy generated by the fuel cell stack as an electric power source. The fuel cell system according to the first embodiment performs air conditioning operation such as heating/cooling indoor air of a passenger compartment of a vehicle using a refrigeration cycle.

FIG. 1 is a schematic configuration of the fuel cell system according to the first embodiment of the present invention. As shown in FIG. 1, the fuel cell system of the first embodiment is equipped with a fuel cell stack 10 capable of generating electrical energy by electrochemical reaction of combining hydrogen gas (or hydrogen) and oxygen gas (or oxygen). The fuel cell stack 10 in the fuel cell system according to the first embodiment is composed of a polymer electrolyte fuel cell (PEFC) in which a plurality of unit cells are stacked, namely, laminated in a multilayered structure. The concept of the present invention is applicable to other types of fuel cells.

The fuel cell stack 10 generates electrical energy by electrochemical reaction of combining hydrogen and oxygen. Hydrogen corresponds to fuel gas, and oxygen corresponds to oxidizing agent gas as defined in claims according to the present invention.

Anode (Hydrogen electrode): 2H₂-->4H⁺+4e⁻,

Cathode (Oxygen electrode): 4H++O₂+4e⁻-->2H₂O, and

Entire of the fuel cell stack: 2H₂+O₂-->2H₂O.

The fuel cell system according to the first embodiment shown in FIG. 1 is composed of a hydrogen supply passage 11 and a hydrogen exhaust passage 12. Through the hydrogen supply passage 11, hydrogen gas is supplied to the hydrogen electrode (anode) in the fuel cell stack 10. The hydrogen gas, not reacted, discharged from the hydrogen electrode in the fuel cell stack 10 flows through the hydrogen exhaust passage 12. A hydrogen gas supply apparatus (not shown) is mounted at the upstream side of the hydrogen supply passage 11, and the hydrogen gas is supplied from the hydrogen gas supply apparatus (not shown) to the fuel cell stack 10 through the hydrogen supply passage 11. The hydrogen gas supply apparatus (not shown) is composed of a hydrogen gas tank in which hydrogen gas of a high pressure is filled.

The fuel cell system according to the first embodiment is equipped with an air supply passage 13 and an air exhaust passage 14. Through the air supply passage 13, oxygen gas (as air) is supplied into the oxygen electrode (cathode) in the fuel cell stack 10. The residual air (oxidizing agent off-gas) which is not reacted to hydrogen is discharge from the oxygen electrode in the fuel cell stack 10 to the outside of the fuel cell system through the air exhaust passage 14. An air supply apparatus is mounted on the air supply passage 13 in order to supply air (as oxidizing agent gas) into the fuel cell stack 10. In the configuration of the fuel cell system according to the first embodiment, an air electric compressor is used as the air supply apparatus which is driven by a drive motor (not shown).

The fuel cell stack 10 generates electrical energy and heat energy. Therefore the fuel cell system needs to incorporate a cooling system capable of cooling the fuel cell stack 10 and to set the temperature of the fuel cell stack 10 to a most suitable temperature (approximately 80° C.) for operation. Such a cooling system is equipped with a cooling water passage 20, a water pump 21, and a radiator 22. Through the cooling water passage 20, the cooling water (heating medium) is circulated in the fuel cells stack 10. The water pump 21 forcedly supplies the cooling water into the cooling water passage 20. For example, ethylene glycol solution is used as the cooling water.

As shown in FIG. 1, the cooling water passage 20 is equipped with a bypath passage 23 through which the cooling water is supplied to the radiator 22. A flow switch valve 24 is located at the junction of the cooling water passage 20 and the bypass passage 23 in order to adjust or control the amount of the flow of the cooling water in the bypass passage 23.

A solenoid valve (or a magnet valve) or a mechanical valve such as a thermostat valve (or a thermo-control valve) can be available as the flow switch valve 24. The heat energy generated in the fuel cell stack 10 is transported to the radiator 22 through the cooling water and discharged to the outside of the fuel cell system by the radiator 22.

The cooling system having the configuration described above can control the temperature of the fuel cell stack 10 based on the flow control of the cooling water performed by the water pump 21 and the amount of flow of the cooling water in the bypass passage 23 performed by the flow switch valve 24.

A cooling water passage 25 for use of controlling the temperature of an indoor first heat exchanger 33 for heating located in the inside of a passenger compartment of a vehicle is mounted on the way of the cooling water passage 20. Through the cooling water passage 25, the cooling water is supplied to the indoor first heat exchanger 33 in order to control the temperature of the indoor air of the passenger compartment of the vehicle.

The cooling water passage 25 branches from the cooling water passage 20 at the downstream side observed from the fuel cell stack 10 and is joined to the cooling water passage 20 at the upstream side of the water pump 21, namely, at the upstream side observed from the fuel cell stack 10, as shown in FIG. 1. The operation of the water pump 21 enables the cooling water to receive the heat energy from the fuel cell stack 10 and to be circulated through the indoor first heat exchanger 33 through the cooling water passage 25.

The fuel cell system of the first embodiment is equipped with an air conditioner device capable of performing air conditioning of the inside of the passenger compartment of the vehicle. The air conditioning device is equipped with an air conditioner cover case 30. The air conditioner cover case 30 forms an air supply passage through which air for air conditioning is supplied to the inside of the passenger compartment. The air conditioner cover case 30 accommodates an air fan 31, an indoor heat exchanger group, and an air mixing door 35, as shown in FIG. 1.

The indoor heat exchanger group is composed of an indoor heat exchanger 32 for cooling, the indoor first heat exchanger 33, and an indoor second heat exchanger 34. The indoor heat exchanger 32, the indoor first heat exchanger 33, and the indoor second heat exchanger 34 correspond to a third heat exchanger, a fifth heat exchanger, and a first heat exchanger, respectively, defined in claims according to the present invention.

Those devices such as the air fan 31, the indoor heat exchanger 32, the air mixing door 35, the indoor first heat exchanger 33, and the indoor second heat exchanger 34 are located in order observed from the left side in FIG. 1. Both the indoor heat exchanger 32 and the indoor second heat exchanger 34 are located in the refrigeration cycle, which will be explained later, and perform heat exchange between the refrigerant and the air for use in the air conditioning.

The indoor first heat exchanger 33 is located in the cooling system for the fuel cell stack 10 and performs the heat exchange between the cooling water and the air for air conditioning.

The air mixing door 35 is located at the upstream side (at the left side observed from the exchangers 33 and 34 in FIG. 1) of the indoor first heat exchanger 33 and the indoor second heat exchanger 34, and is operable by an electric motor (not shown).

The opening ratio of the air mixing door 35 is controlled in order to control the amount of air passing through the indoor first heat exchanger 33 and the indoor second heat exchanger 34. The controller 100 as the ECU (Electric Control Unit) can control the operation of the air mixing door 35. The operation of the controller 100 will be explained later.

The fuel cell system is equipped with the refrigeration cycle in order to perform the heating and cooling of the indoor air in the passenger compartment of the vehicle. The refrigeration cycle is equipped with a refrigerant circulation passage 40 through which the refrigerant is circulated. The refrigerant circulation passage 40 is composed of pipes in which the refrigerant is sealed. For example, HFC-134a or CO₂ can be used as the refrigerant.

An electric compressor 41, the indoor second heat exchanger 34, a decompressor 43 for heating, an outdoor heat exchanger 42, an exhaust gas heat exchanger 44, a decompressor 46 for cooling, the indoor heat exchanger 32 and the like are located in the refrigerant circulation passage 40 in order observed from the upstream side of the refrigerant.

The electric compressor 41 compresses the refrigerant in gas condition and outputs the compressed refrigerant. For instance, in the cooling operation mode, the refrigerant of a high temperature compressed by the electric compressor 41 is introduced into the indoor second heat exchanger 34. The outdoor heat exchanger 42 performs the heat exchange between the refrigerant and the outdoor air in order to cool the refrigerant.

The decompressor 43 for heating and the exhaust gas heat exchanger 44 are located at both sides of the outdoor heat exchanger 42 in the refrigerant circulation passage 40. That is, as shown in FIG. 1, the outdoor heat exchanger 42 is located between the decompressor 43 and the exhaust gas heat exchanger 44 in the refrigerant circulation passage 40.

A refrigerant passage switch valve 45 as the refrigerant passage switch means is located in the refrigerant circulation passage 40. The refrigerant passage switch valve 45 switches the flowing direction of the refrigerant in the outdoor heat exchanger 42 according to the cooling operation mode and the heating operation mode under the control of the ECU 100 as the control means.

The refrigerant passage switch valve 45 is configured to switch the flowing direction of the refrigerant in the outdoor heat exchanger 42 according to the heating/cooling operation modes for the passenger compartment of the vehicle. For example, a four way valve is available as the refrigerant passage switch valve 45. In the heating operation mode for heating the indoor air of the passenger compartment of the vehicle, the refrigerant passage switch valve 45 makes the refrigerant flow so that the refrigerant is circulated form the decompressor 43 to the exhaust gas heat exchanger 44 through the outdoor heat exchanger 42. On the contrary, during the cooling operation mode for cooling the indoor air of the passenger compartment of the vehicle, the refrigerant passage switch valve 45 makes the refrigerant flow so that the refrigerant is circulated form the exhaust gas heat exchanger 44 to the decompressor 43 through the outdoor heat exchanger 42.

The decompressor 43 for heating corresponds to the second decompressor defined in claims according to the present invention. The decompressor 46 for cooling corresponds to the first decompressor defined in claims according to the present invention. The refrigerant passage switch valve 45 corresponds to the refrigerant passage switch means defined in claims according to the present invention.

The degree of the opening of the decompressor 43 is adjustable under the control of the ECU 100. The decompressor 43 is an electric expansion valve having a full open capability.

In the heating operation mode, the decompressor 43 is positioned at the upstream side in the refrigerant flow observed from the outdoor heat exchanger 42 and used as a throttle valve through which the refrigerant of a low temperature and a low pressure is supplied into the outdoor heat exchanger 42.

On the contrary, during the cooling operation mode, the decompressor 43 is positioned at the downstream side of the refrigerant flow observed from the outdoor heat exchanger 42 and becomes a full open state in order to supply the refrigerant of a high pressure supplied from the outdoor heat exchanger 42 to the decompressor 46 for cooling positioned at the downstream side of the refrigerant flow observed from the outdoor heat exchanger 42. The exhaust gas heat exchanger 44 is configured to perform the heat exchange between the exhaust gas (namely, the exhaust air) in the air exhaust passage 14 emitted from the oxygen electrode in the fuel cell stack 10 and the refrigerant flowing through the refrigerant circulation passage 40. Because the exhaust air receives the waste heat energy from the fuel cell stack 10, the exhaust air has a temperature range of approximately 60 to 80° C.

During the heating operation mode, the exhaust gas heat exchanger 44 is positioned at the downstream side observed from the outdoor heat exchanger 42. The temperature of the refrigerant is increased using the heat energy of the outdoor air through the outdoor heat exchanger 42, and further increased using the exhaust air provided from the fuel cell stack 10 in the exhaust gas heat exchanger 44.

On the contrary, during the cooling operation mode, the exhaust gas heat exchanger 44 is positioned at the upstream side observed from the outdoor heat exchanger 42. The exhaust gas heat exchanger 44 performs heat exchange between the refrigerant of a high temperature emitted from the electric compressor 41 and the exhaust air emitted from the fuel cell stack 10 in order to cool the refrigerant.

The decompressor 46 for cooling is located at the upstream side in the refrigerant circulation passage 40 observed from the indoor heat exchanger 32. The decompressor 46 for cooling decreases the pressure of the refrigerant in liquid state in order to make the refrigerant of a low pressure in a two-phase liquid state.

The decompressor 46 for cooling is composed of a mechanical type expansion valve, and adjusts the amount of the refrigerant flow according to the temperature of the refrigerant at the outlet of the indoor heat exchanger 32 in order that the temperature of the refrigerant at the outlet of the indoor heat exchanger 32 approaches a predetermined value.

The refrigerant of a low pressure supplied from the decompressor 46 for cooling flows into the indoor heat exchanger 32. The refrigerant of a low pressure flowing into the indoor heat exchanger 32 absorbs the heat energy of the air in the air conditioner cover case 30 and thereby evaporated.

A refrigerant bypass passage 47 branches from the refrigerant circulation passage 40 before a second refrigerant passage switch valve 49, shown in FIG. 1, in order to bypass the indoor heat exchanger 32.

A first refrigerant passage switch valve 48 is located in the refrigerant bypass passage 47, and a second refrigerant passage switch valve 49 is located between the branch node of the refrigerant bypass passage 47 and the decompressor 46 for cooling in the refrigerant circulation passage 40 in order to switch the refrigerant flow into the direction of the indoor heat exchanger 32 for cooling or into the refrigerant bypass passage 47.

In the heating operation mode, it is so controlled, namely, the ECU 100 controls that the first refrigerant passage switch valve 48 is open and the second refrigerant passage switch valve 49 is closed so as to flow the refrigerant through the refrigerant bypass passage 47. In the cooling operation mode, it is so controlled, namely, the ECU 100 controls that the first refrigerant passage switch valve 48 is closed and the second refrigerant passage switch valve 49 is open in order to flow the refrigerant through the indoor heat exchanger 32 for cooling.

FIG. 2 is a block diagram of input/output of the control unit 100, namely, the ECU 100 in the fuel cell system according to the first embodiment shown in FIG. 1.

As shown in FIG. 2, the fuel cell system is equipped with the control unit 100 as a controller capable of performing various control operation. The control unit 100 is composed mainly of a microcomputer including a CPU, a ROM, and a RAM, and peripheral circuits, and the like. The control unit 100 receives various sensor signals transferred from various types of sensors and other control signals. The control unit (ECU) 100 calculates based on the sensor signals, and generates and outputs control signals to various devices such as the water pump 21, the flow switch valve 24, the air fan 31, the air mixing door 35, the electric compressor 41, the decompressor 43 for heating, the refrigerant passage switch valve 45, the first refrigerant passage switch valve 48, the second refrigerant passage switch valve 49, and other devices based on the calculation results. In the configuration of the fuel cell system according to the first embodiment, although the control unit 100 controls the operation of the fuel cell system and the air conditioning operation, it is possible to incorporate two or more control units (ECUs) in the fuel cell system in order that each device is controlled by each control unit and data communication is performed between the control units.

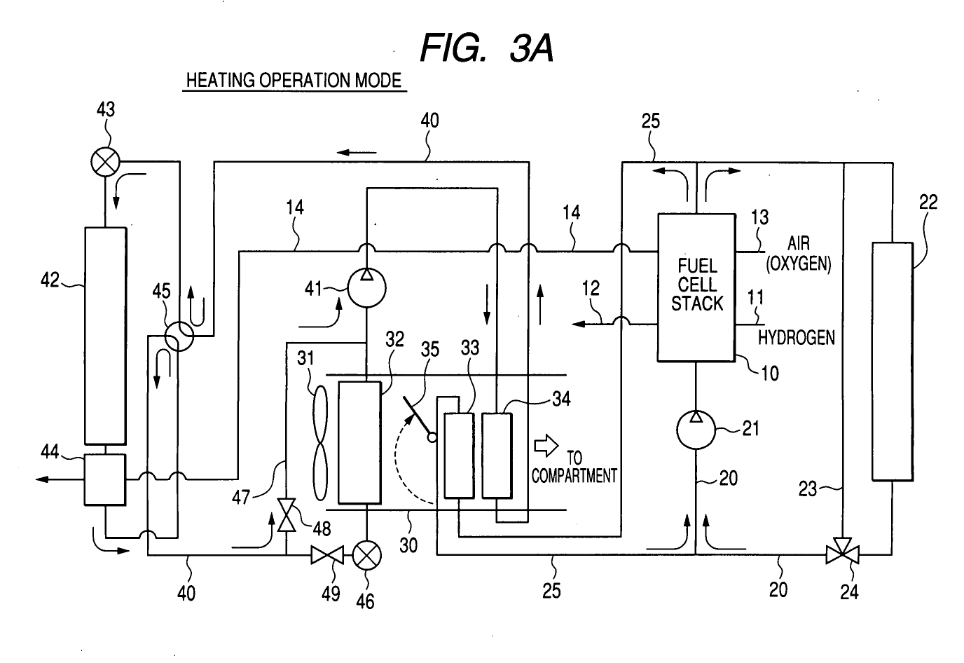

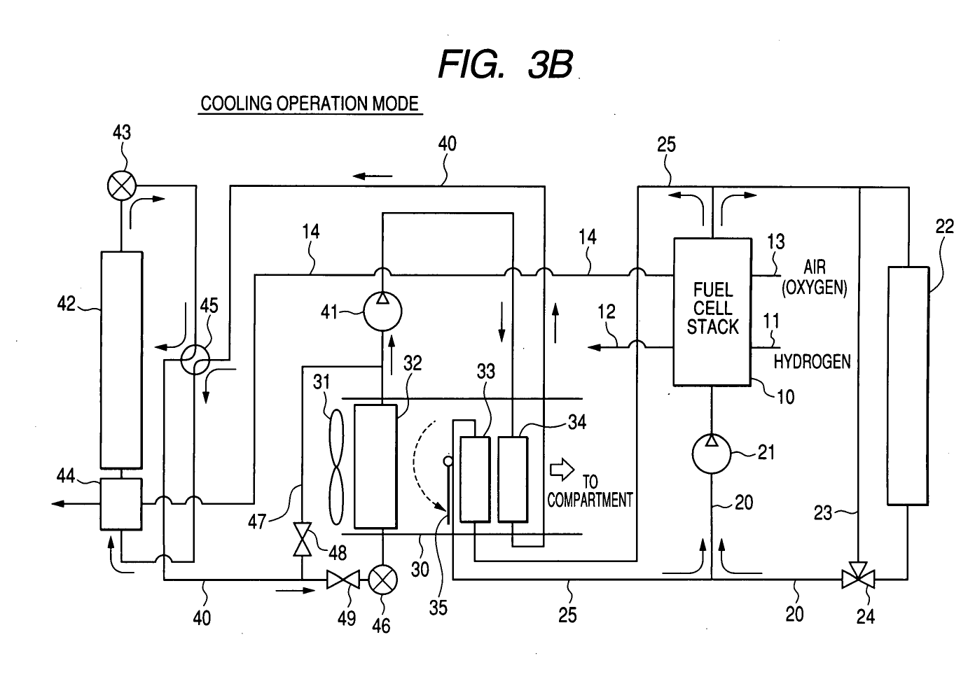

Next, a description will now be given of the operation of the fuel cell system according to the first embodiment with reference to FIG. 3A and FIG. 3B. FIG. 3A is a schematic view showing the refrigerant flow or refrigerant stream in the heating operation mode of the refrigeration cycle in the fuel cell system according to the first embodiment shown in FIG. 1. FIG. 3B is a schematic view showing the refrigerant flow in the cooling operation mode of the refrigeration cycle in the fuel cell system according to the first embodiment shown in FIG. 1.

An operator or a driver of a vehicle handles an air conditioning mode switch (not shown) in order to switch the heating operation mode and the cooling operation mode for the air conditioning. It is acceptable to automatically switch the heating operation mode and the cooling operation mode for the air conditioning according to calculation results of the control unit (such as the ECU 100) based on the state of the air conditioning switch (not shown), a detected outdoor temperature, a detected indoor temperature, and the like.

Before initiating the air conditioning operation, the fuel cell stack 10 is in operate and the cooling water for use of cooling the fuel cell stack 10 is circulated through the indoor first heat exchanger 33.

A description will now be given of the heating operation mode in the fuel cell system with reference to FIG. 3A.

In the heating operation mode, the control unit 100 instructs the air fan 31 to operate. The control unit 100 controls the opening ratio of the air mixing door 35 according to a target temperature in the air conditioning. Further, the control unit 100 adjusts the ratio of air passing through the indoor first heat exchanger 33 and the indoor second heat exchanger 34. The air for use in the air conditioning operation is heated by the heat energy generated in the electrochemical reaction of combining hydrogen and oxygen in the fuel cell stack 10 through the cooling water when the air for the air conditioning passes through the indoor first heat exchanger 33 for heating. This can heat the indoor air of the passenger compartment of the vehicle using the heat energy generated in the fuel cell stack 10.

After the heat energy is discharged from the cooling water in the indoor first heat exchanger 33, the cooling water is returned to the cooling water passage 20 through the cooling water passage 25. Because the above heating operation can use the waste heat energy generated by the electric power generation in the fuel cell stack 10, in order to heat the indoor air of the passenger compartment of the vehicle, it is possible to decrease the total heat energy necessary to heat the indoor air of the passenger compartment until reaching a target temperature in the heating operation mode. As a result, this can improve the operation efficiency of the vehicle.

Further, in the heating operation mode, the flow of the refrigerant is switched to the passage which is composed of the decompressor 43 for heating, the outdoor heat exchanger 42, and the exhaust gas heat exchanger 44 in order. The first refrigerant passage switch valve 48 is open and the second refrigerant passage switch valve 49 is closed in order to flow the refrigerant through the refrigerant bypass passage 47 by bypassing the indoor heat exchanger 32.

The refrigerant of a high pressure and a high temperature compressed by the electric compressor 41 is supplied into the indoor second heat exchanger 34 for heating, the heat energy of the refrigerant is then conducted to the air for use in the air conditioning through the indoor second heat exchanger 34 in order to heat the air for use in the air conditioning. This can heat the indoor air of the passenger compartment of the vehicle using the waste heat energy generated in the refrigeration cycle. The temperature of the cooling water for use of cooling the fuel cell stack 10 is gradually increased counted from the initiation of the electric power generation in the fuel cell stack 10. On the contrary, the temperature of the refrigerant compressed by the electric compressor 41 in the refrigeration cycle can be rapidly increased and reaches a high temperature as the target temperature. Because the heating operation using the refrigerant in the refrigeration cycle can rapidly heat the indoor air of the passenger compartment, it is possible to perform the heating operation for the passenger compartment immediately following the initiation of the operation of the fuel cell stack 10.

The temperature of the refrigerant from the indoor second heat exchanger 34 for heating is decreased to a low temperature (until approximately −40° C.) by the decompressor 43 for heating. The refrigerant supplied from the decompressor 43 then receives the heat energy from the outdoor heat exchanger 42, and the temperature of the refrigerant is thereby increased. The refrigerant from the outdoor heat exchanger 42 further receives the heat energy from the exhaust air emitted from the fuel cell stack 10 in the exhaust and the temperature thereof is further increased. At this time, when the temperature of the refrigerant from the outdoor heat exchanger 42 is approximately −20° C. and the temperature of the exhaust air emitted from the fuel cell stack 10 is within a range of approximately 60 to 80° C., for example, the difference between those temperatures is within a range of 80 to 100° C. This temperature difference can efficiency increase the refrigerant using the sensible heat energy of the exhaust air. Still further, the exhaust air emitted from the fuel cell stack 10 contains water vapor as produced water generated in the electrochemical reaction of combining hydrogen and oxygen in the fuel cell stack 10. Since the water vapor of the produced water is condensed when the exhaust air is cooled by the exhaust gas heat exchanger 44, the latent heat in condensation of the vapor water can be conducted to the refrigerant.

The refrigerant whose temperature increases by the exhaust gas heat exchanger 44 is circulated and returns to or reaches the electric compressor 41 through the refrigerant bypass passage 47. Because the temperature of the refrigerant is increased by the heat exchange between the refrigerant and the outdoor air in the outdoor heat exchanger 42 and by the heat exchange between the refrigerant and the exhaust air from the fuel cell stack 10 by the exhaust gas heat exchanger 44, the pressure of the refrigerant is thereby increased. Because this can decrease the load of the electric compressor 41, it is thereby possible for the fuel cell system of the first embodiment to efficiently use the waste heat energy from the fuel cell stack 10.

Next, a description will now be given of the cooling operation mode in the refrigeration cycle of the fuel cell system with reference to FIG. 3B.

In the cooling operation mode, the control unit 100 drives the air fan 31 and controls the opening ratio of the air mixing door 35 according to a target temperature for the cooling operation mode in the refrigeration cycle in order to adjust the amount of the air for use in the air conditioning passing through the indoor first heat exchanger 33 and the indoor second heat exchanger 34. The refrigerant passage switch valve 45 switches the current passage to the passage which is composed of the exhaust gas heat exchanger 44, the outdoor heat exchanger 42, and the decompressor 43 for heating in order. The decompressor 43 for heating is fully open. The first refrigerant passage switch valve 48 is closed and the second refrigerant passage switch valve 49 is open instead in order to flow the refrigerant through the indoor heat exchanger 32 for cooling.

The refrigerant of a high temperature and a high pressure compressed by the electric compressor 41 passes through the indoor second heat exchanger 34. The refrigerant is then supplied into the exhaust gas heat exchanger 44. The heat energy of the refrigerant is conducted to the exhaust air emitted from the fuel cell stack 10 and the refrigerant is thereby cooled. At this time, when the temperature of the refrigerant from the indoor second heat exchanger 34 is approximately 150° C. and the temperature of the exhaust air emitted from the fuel cell stack 10 is within a range of approximately 60 to 80° C., for example, the difference between those temperatures is within a range of 70 to 90° C. This temperature difference can efficiency decrease the temperature of the refrigerant using the sensible heat energy of the exhaust air. Still further, the exhaust air from the fuel cell stack 10 contains water drops in addition to water vapor as produced water generated in the electrochemical reaction of combining hydrogen and oxygen in the fuel cell stack 10. Since the water drop of the produced water is vaporized when the exhaust air is heated in heat exchange operation by the exhaust gas heat exchanger 44, the latent heat in vaporization of the vapor water can cool the refrigerant, and the pressure of the refrigerant is thereby decreased. The refrigerant from the exhaust gas heat exchanger 44 is cooled in liquid state by the heat exchange between the refrigerant and the outdoor air by the outdoor heat exchanger 42.

The refrigerant from the outdoor heat exchanger 42 passes through the decompressor 43 which is fully open, and supplied to the decompressor 46. The refrigerant of a low temperature and a low pressure supplied from the decompressor 46 for cooling is supplied into the indoor heat exchanger 32 in order to cool the air for use in the air conditioning. The temperature of the air for use in the air conditioning is adjusted according to a target temperature by the indoor first heat exchanger 33 and the indoor second heat exchanger 34, and the air is then supplied into the inside of the passenger compartment of the vehicle. The above operation can perform the cooling operation mode for the passenger compartment of the vehicle.

As described above, according to the fuel cell system of the first embodiment of the present invention, because the air for use in the air conditioning is heated using the heat energy of the refrigerant of a high temperature compressed by the electric compressor 41 during the heating operation mode, it is possible to rapidly initiate the heating operation for the passenger compartment of the vehicle immediately following the initiation of operation of the fuel cell stack 10. This can improve the rapid heating operation.

In addition, the simple configuration composed of the exhaust gas heat exchanger 44 and the refrigerant passage switch valve 45 can conduct the sensible heat energy of the exhaust air discharged from the fuel cell stack 10 and the latent heat energy of the produced water in the electrochemical reaction in the fuel cell stack 10 to the refrigerant, where the exhaust gas heat exchanger 44 is capable of performing the heat exchange between the exhaust air emitted from the fuel cell stack 10 and the refrigerant at the upstream side or the downstream side observed from the outdoor heat exchanger 42. This can improve the efficiency of the heating operation mode and the cooling operation mode. That is, during the heating operation mode, it is possible to further heat the refrigerant, which has been heated by the outdoor heat exchanger 42, by the sensible heat energy of the exhaust air emitted from the fuel cell stack 10 and the latent heat energy in condensation of the produced water using the refrigerant passage from the outdoor heat exchanger 42 to the exhaust gas heat exchanger 44. It is thereby possible to reduce the load of the electric compressor 41 by increasing the pressure of the refrigerant and to increase the efficiency of the fuel cell system. On the other hand, in the cooling operation mode, making the refrigerant flow from the exhaust gas heat exchanger 44 to the outdoor heat exchanger 42 enables that the refrigerant is cooled in advance by the sensible heat energy of the exhaust air discharged from the fuel cell stack 10 and the latent heat energy in vaporization of the water product can cool the refrigerant before the operation of cooling the refrigerant is initiated by the outdoor heat exchanger 42. It is thereby possible to efficiently decrease the temperature of the refrigerant in order to decrease the pressure of the refrigerant. This can enhance the efficiency of the cooling operation by the fuel cell system. In this case (this embodiment), the refrigerant is using CO₂.

### Second Embodiment

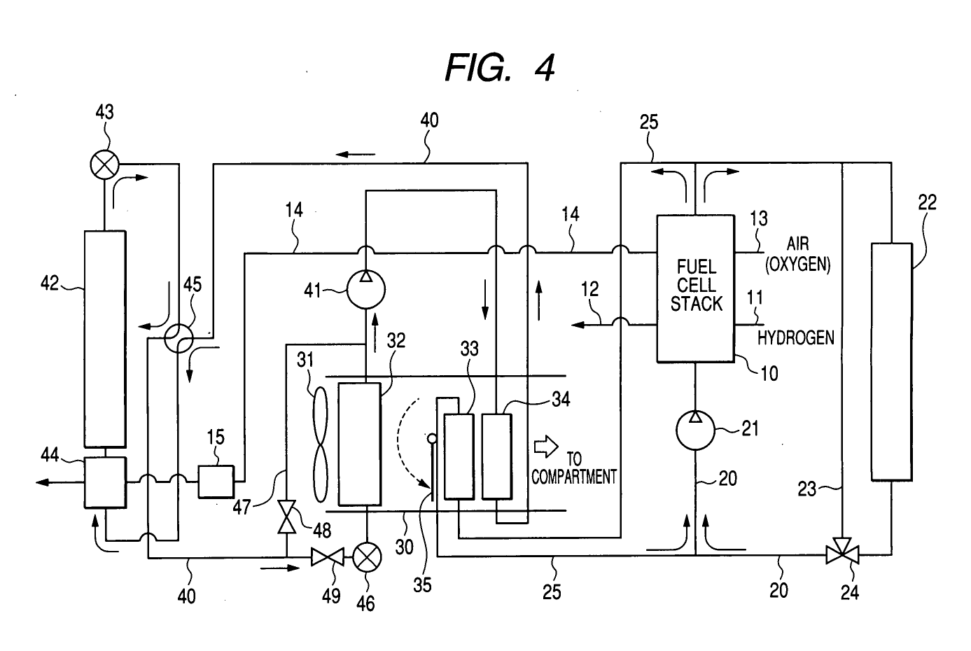

A description will be given of the fuel cell system of a second embodiment according to the present invention with reference to FIG. 4. The difference in configuration and operation between the second embodiment shown in FIG. 4 and the first embodiment shown in FIG. 1 to FIG. 3B will be explained.

FIG. 4 is a schematic configuration of the fuel cell system according to the second embodiment of the present invention. In the configuration of the fuel cell system of the second embodiment shown in FIG. 4, a mist accelerator 15 is located at the upstream side observed from the exhaust gas heat exchanger 44 in the air exhaust passage 14. The mist accelerator 15 makes a mist state of the produced water involved in the exhaust air emitted from the fuel cell stack 10. Thus, the mist accelerator 15 promotes the mist state of the produced water. The mist accelerator 15 consists of an ultrasonic wave generator having an ultrasonic wave oscillator capable of generating ultrasonic wave. The mist accelerator 15 generates ultrasonic wave and the ultrasonic wave is supplied into the exhaust air containing water component. On receiving the ultrasonic wave, the water component contained in the exhaust air is changed to the mist state of fine water particles.

Since the exhaust air emitted from the fuel cell stack 10 is in a super saturation condition, the water component in the exhaust air is changed to the mist state by the mist accelerator 15 in the cooling operation mode. This operation of the mist accelerator 15 can increase the total amount of fine water particles of the mist state in the exhaust air which can be easily evaporated by the exhaust gas heat exchanger 44. As a result, it is possible to increase the latent heat energy of the produced water in evaporation during the cooling operation mode, and thereby to improve the cooling efficiency of the refrigerant by the exhaust gas heat exchanger 44. This can also improve the operational efficiency of the fuel cell system.

### (Other Modifications)

Although the fuel cell system according to each of the first and second embodiments described above takes the configuration in which the indoor second heat exchanger 34 is located at the downstream side observed from the electric compressor 41 in the refrigerant circulation passage 40 in order to perform the heat exchange between the refrigerant of a high temperature compressed by the electric compressor 41 and the air for use in the air conditioning, it is possible to have another configuration from which the indoor second heat exchanger 34 is eliminated. In this configuration without the indoor second heat exchanger 34, the refrigerant passage is so formed that the refrigerant from the electric compressor 41 is supplied into the indoor heat exchanger 32 and the indoor heat exchanger 32 acts as an indoor heater for heating the indoor air of the passenger compartment of the vehicle.

Further, although the fuel cell system according to the second embodiment described above, as shown in FIG. 4, uses the ultrasonic wave generator as the mist accelerator 15, the present invention is not limited by this configuration. It is possible to use devices capable of misting the water component contained in the exhaust air emitted from the fuel cell stack 10. For example, it is possible to use a diffuser and the like capable of increasing the pressure of the exhaust air in order to perform a phase change of water drops contained in the exhaust air to fine water particles. It is also possible to use a heat exchanger as the mist accelerator 15. In this case, the heat exchanger performs heat exchange between the exhaust air emitted from the fuel cell stack 10 and the refrigerant of a low temperature supplied from the indoor heat exchanger 32, and the ultrasonic wave generator mists water drops which have been condensed by the heat exchanger. Still further, it is also possible to use outdoor air instead of the air for use in the refrigeration cycle for the air conditioning in the fuel cell system.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. A fuel cell system comprising:
a fuel cell stack which generates electrical energy by electrochemical reaction of combining oxidizing agent gas and fuel gas;
a compressor which compresses air for use in air conditioning;
a first heat exchanger which performs heat exchange between an outdoor air and a refrigerant emitted from the compressor;
a second heat exchanger which performs heat exchange between the air (indoor and outdoor) and the refrigerant;
a first decompressor which decreases a pressure of the refrigerant flowing from the second heat exchanger;
a third heat exchanger which cools the air for the air conditioning by evaporating the refrigerant whose pressure is decreased by the first decompressor;
a second decompressor which decreases the pressure of the refrigerant compressed by the compressor;
a fourth heat exchanger which performs heat exchange between the refrigerant and the oxidizing agent off-gas emitted from the fuel cell stack; and
refrigerant passage switch means which selects one of a refrigerant passage for a cooling operation mode and a refrigerant passage for a heating operation mode, where the refrigerant passage for a cooling operation mode being composed of the fourth heat exchanger, the second heat exchanger and the second decompressor in order, and the refrigerant passage for the heating operation mode being composed of the second decompressor, the second heat exchanger, and the fourth heat exchanger in order,
wherein during the cooling operation mode, the refrigerant emitted from the compressor is cooled by the oxidizing agent off-gas exhausted from the fuel cell stack, the refrigerant is cooled using the outdoor air by the second heat exchanger, and passes without being decompressed with second decompressor which is fully open, the pressure of the refrigerant is then decreased by the first decompressor, the refrigerant is evaporated by the third heat exchanger in order to cool the air for use in the air conditioning, and the refrigerant is returned to an inlet of the compressor, and in the heating operation mode, the refrigerant emitted from the compressor heats the air for the air conditioning, the pressure of the refrigerant is decreased by the second decompressor, the refrigerant is heated using the outdoor air by the second heat exchanger, the refrigerant is heated using the oxidizing agent off-gas discharged from the fuel cell stack by the fourth heat exchanger, and the refrigerant is returned to the inlet of the compressor.

2. The fuel cell system according to claim 1, further comprising a mist accelerator, located before a position where the oxidizing agent gas emitted from the fuel cell stack flows into the fourth heat exchanger, capable of generating mist of water component contained in the oxidizing agent gas emitted from the fuel cell stack.

3. The fuel cell system according to claim 1, further comprising a fifth heat exchanger which performs heat exchange between cooling water for cooling the fuel cell stack and the air for the air conditioning, and for heating the air for the air conditioning.

4. The fuel cell system according to claim 2, further comprising a fifth heat exchanger which performs heat exchange between cooling water for cooling the fuel cell stack and the air for the air conditioning, and for heating the air for the air conditioning.

5. The fuel cell system according to claim 1, wherein the first decompressor is a mechanical expansion valve, the second decompressor is an electrical expansion valve, and the refrigerant passage switch means is a four way valve.

6. The fuel cell system according to claim 1, further comprising a controller configured to control the operation of the fuel cell stack, the compressor, the first heat exchanger, the second heat exchanger, the first decompressor, the third heat exchanger, the second decompressor, the fourth heat exchanger, and the refrigerant passage switch means so that the refrigerant passages through which the refrigerant flows are formed according to the cooling operation mode and the heating operation mode.

7. The fuel cell system according to claim 1, wherein the oxidizing agent gas is oxygen and the fuel gas is hydrogen.
